(19) United States
(12) Patent Application Publication
(10) Pub. No.: US 2005/0069857 A1
(43) Pub. Date: Mar. 31, 2005

(54) Inflatable full scale printer model

(75) Inventors: Edward J. Sullivan, Fairport, NY (US); Thomas L. Schwartz, Fairport, NY (US)

Correspondence Address: Lawrence P. Kessler;Patent Legal Staff, Eastman Kodak Company, 343 State Street, Rochester, NY, 14650-2201, US

(73) Assignee: Eastman Kodak Company

(21) Appl. No.: 10/945,488

(22) Filed: Sep. 20, 2004

Related U.S. Application Data
(60) Provisional application No. 60/507,232, filed on Sep. 30, 2003.

(51) Int. Cl. G09B 25/00

(52) U.S. Cl. 434/365

(57) ABSTRACT

An inflatable full scale model of a printing device, or the like. This full scale model includes a readily inflatable body having a predetermined shape, when inflated, corresponding to a selected printing device. The body includes features representing utility hook-up locations for the selected printing device. When the body is inflated, it can be used to facilitate site planning and utility connection needs at a particular site.

### FIELD OF THE INVENTION

This invention relates in general to printers and the like, and more particularly to an inflatable full scale model of a printer to facilitate assessment of a desired printer site location at a customer site.

### BACKGROUND OF THE INVENTION

Modem, high volume printers and copier/duplicators devices, and the like, are of varied complexity and a wide range of configurations ranging from basic to intricately complex, depending upon the selected printer device and any associated accessories. Such printing devices assume many shapes, based for example on the technology employed to carry out their desired functions. The many configurations require different floor space areas, again depending on the printing device configuration and accessories associated therewith. Further, the printing devices may respectively require both standard and specialized utility connections. It is necessary to have an idea of the availability for connections of the printing devices (and accessories) to the utilities, such as electricity, air handling, or water supplies, for example. It is important to be able to readily determine the footprint for these printing devices, and their utility connections, so as to be assured that they will be suitable at a desired site as to both fit and utility availability and connection.

In the past, the site planner had to approximate the size of the printing devices and accessories when selecting and evaluating a desired site. Further, the connections to utilities had to be surmised. Placement of the printing devices, and the provision of suitable utility connections, has therefore largely been accomplished through guesswork or trial-and-error. Many customers today are unsure of site location suitability and are not comfortable installing connections for utilities prior to the printing device being properly located onsite. This leads to considerable delays in getting the printing device installed at the customer site, and bringing the printing device online into an operational, profit producing mode.

### SUMMARY OF THE INVENTION

In view of the above, this invention is directed to a method and apparatus for facilitating site evaluation and preparation for a selected printing device, including associated accessories therefore, or the like. To accomplish the desired result, an inflatable full scale model of the selected printing device is provided. This full scale model includes a readily inflatable body having a predetermined shape, which when inflated, corresponds to a selected printing device. The body includes features representing utility hook-up locations for the selected printing device. These hook-up connection features include, for example, location points for electric power connections, compressed air connections, water connections, drain connections, network connections, modem connections, and/or environmental control system connections. When the body is inflated, it can be used to facilitate site evaluation and preparation for the selected printing device (and any required associated accessories), and utility connection needs at a particular site. As a result, the inflated model would eliminate the uncertainty as to suitability of a customer site location and the propriety of utility connections for the selected printing device. Thus, it will provide assurance that the site, including utility connections, is ready at the time the selected printing device is delivered to the site.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawings, in which:

FIG. 1 is a view, in perspective, of the selectively inflatable full scale printing device model, in a deflated condition, and an inflation pump, in a delivery container, according to this invention;

FIG. 2 is a front view, in perspective, of the selectively inflatable full scale printing device model, in an inflated condition, showing the utility connections, according to this invention;

FIG. 3 is a rearview, in perspective, of the selectively inflatable full scale printing device model, in an inflated condition, according to this invention; showing the utility connections;

FIG. 4 is a top plan view, of the selectively inflatable full scale printing device model, in an inflated condition, showing the foot print of the printing device and utility connection locations thereof; and

FIGS. 5A and 5B, are perspective and top plan views, respectively, of a selectively inflatable full scale model of an accessory for a printing device, according to this invention.

### DETAILED DESCRIPTION OF THE INVENTION

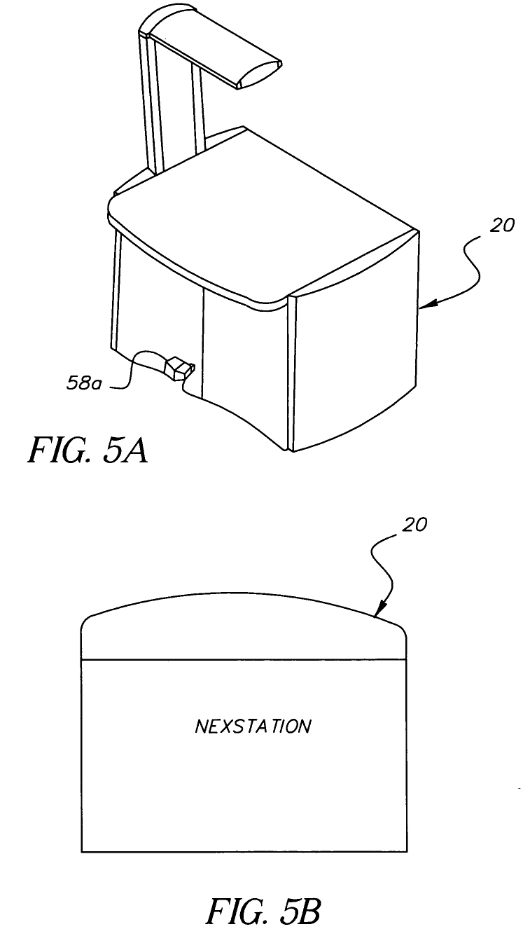

Referring now to the accompanying drawings, a selectively inflatable full scale model of a selected printing device, according to this invention, is designated generally by the numeral 10. The printing device model 10, when inflated in the manner described below, corresponds to a full scale model of any desired selected printing device, and includes features which indicate where necessary utilities are to be connected to the specific selected printing device. The features include connections for utilities such as electric power connections, compressed air connections, water connections, drain connections, network connections, modem connections, or environmental control system connections. Further, the printing device model may also include any accessories (see FIGS. 5A and 5B) that may be desired (or required) to be used with the selected printing device. By utilization of such a full scale printing device model 10, a full and complete evaluation and assessment of a customer site may be made to determine suitability and/or needs of the site to properly accommodate the particular selected printing device (and any associated accessories), as well as the utilities required (and their proper location relative to the printing device).

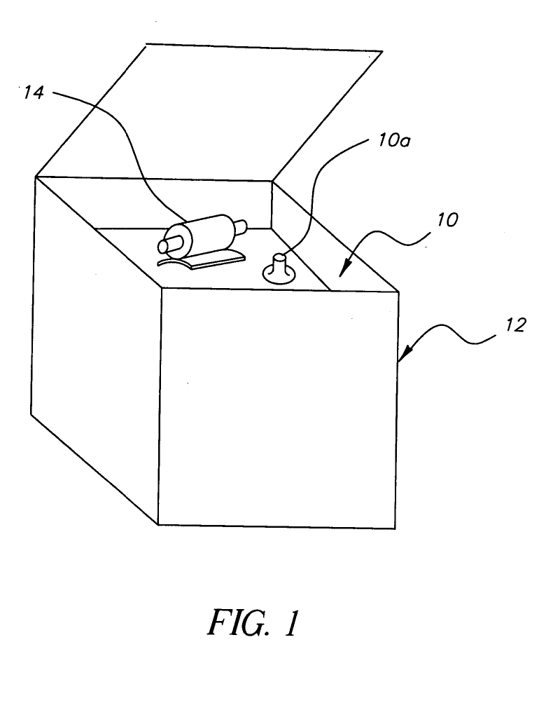

FIG. 1 shows a view, in perspective, of printing device model 10, in a deflated condition, in a delivery container 12. Any suitable inflation device 14, such as pump, may be included in the delivery container 12. The delivery container 12 can then be easily brought to a customer site, and the printing device model, with associated accessories, readily deployed using the inflation device 14. At a selected location at the customer site, the deflated printing device model 10 is unpacked, and connected at a suitable fill valve 10a, to the inflation device 14. The inflation device 14 is turned on, and the printing device is readily inflated until it assumes the full scale size for the selected printing device.

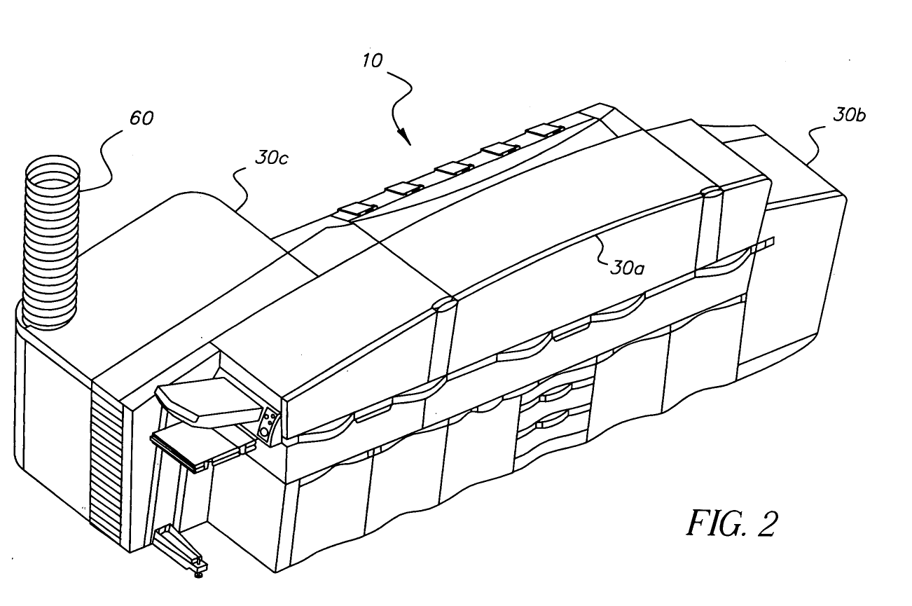

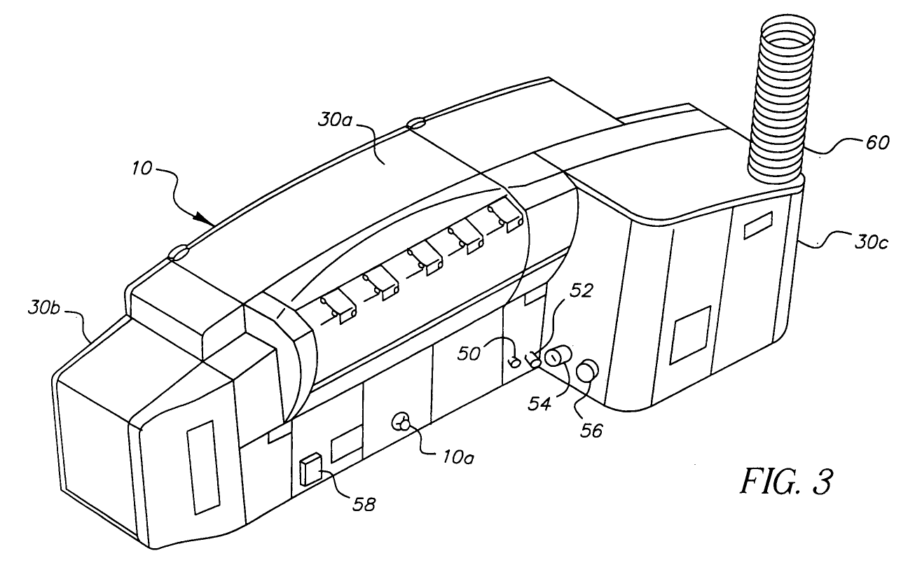

The inflatable full scale printing device model 10 is shown in an inflated condition in FIGS. 2 to 4. In this specific instance, the printing device model 10 shown in the accompanying drawings is that of a NexPress 2100 Color On Demand Printer from NexPress Solutions, Inc., of Rochester, N.Y. Of course, many other particular printing devices could be made into full scale models for use with this invention. In addition to the full scale printing device model 10, any desired (or required) accessory could also be provided in a full scale model. As shown in FIGS. 5A and 5B, a full scale model 20 of a NexStation accessory for the NexPress 2100 Color On Demand Printer is provided. In this manner, the suitability of a customer site for both the selected printing device and any desired/required accessories to be associated therewith can be accurately assessed.

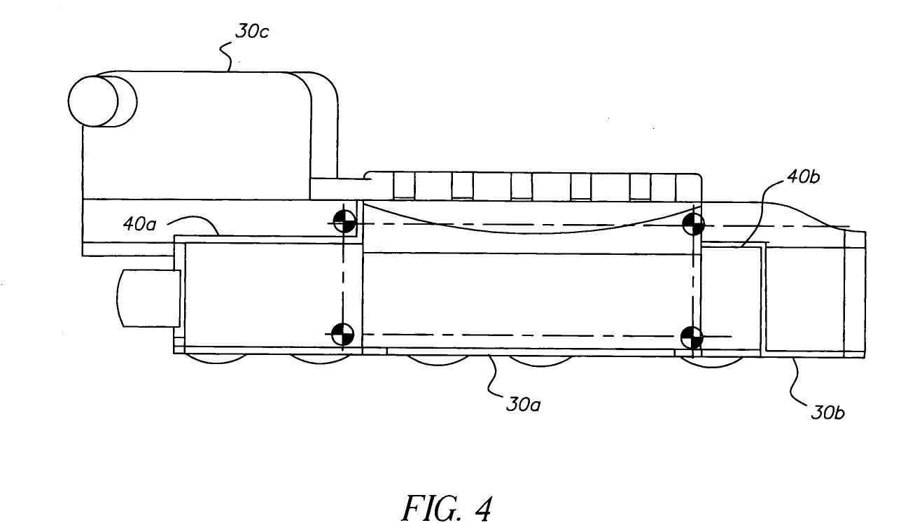

The printing device model 10 has all the details, in full scale for the specific selected printing device. In the example of FIGS. 2-4, the printing device model 10 includes a representation of the main print engine housing 30a, as well as the right frame section 30b and the environmental control section 30c. The printing device model 10 may be of one-piece construction, or for convenience purposes, may be made up of several components. In the particular printing device model shown, several components are provided, configured to correspond to the different sections of the printing device; i.e., the main print engine housing, the right section, and the environmental control section. As best seen in FIG. 4, these individual sections are connected by any suitable fastener mechanisms 40a, 40b, such as VELCRO™ for example.

As noted above, the printing device model 10, according to this invention, includes appropriate features representing utility connections. These connections include an electric power connection 50, a compressed air connection 52, a water connection 54, a drain connection 56, a network connection and modem connection 58, and an environmental control system exhaust connection 60. Similarly, any appropriate utility connection for an accessory can be provided; see, for example, the network connection and modem connection 58a for the accessory 20 of FIGS. 5A, 5B. Of course the utility connections described herein are only exemplary, and are tailored to the requirements of the particular printing device (and any accessories) to be evaluated and assessed. Other utility connections and their arrangements are suitable for use with this invention and are dependent upon the particular configuration and requirements of the specific printing device being evaluated and assessed for site suitability.

With the full scale printing device model 10 properly set up and inflated at the customer site, the site can be evaluated for suitability for permanent installation of the corresponding selected printing device. The footprint of the printing device, as well as the surrounding spacings can be readily determined (see FIG. 4) and evaluated. Also, the location of the various utilities can be determined, from the noted utility-representing features, and assessed for suitability or necessary additional utility connectors. With the full scale printing device model 10, according to this invention, site evaluation and assessment can be readily accomplished for suitability, or any modifications that may be required, before the printing device is delivered to the site.

The invention has been described in detail with particular reference to certain preferred embodiments thereof, but it will be understood that variations and modifications can be effected within the spirit and scope of the invention.

1. An inflatable full scale model of a printing device, or the like, said model comprising:
a readily inflatable body having a predetermined shape, when inflated, corresponding in full scale to a selected printing device, said body including features representing utility hook-up locations for the selected printing device, wherein said body when inflated can be used to facilitate site assessment and planning, and utility connection needs at a particular site for said selected printing device.

2. An inflatable full scale model of a printing device, or the like, according to claim 1, wherein said features representing utility hook-up locations include locations for at least one of the following utilities: electric power connections, compressed air connections, water connections, drain connections, network connections, modem connections, or environmental control system connections.

3. An inflatable full scale model of a printing device, or the like, according to claim 1, further including a readily inflatable body having a predetermined shape, when inflated, corresponding, in full scale to an accessory for said selected printing device.

4. An inflatable full scale model of a printing device, or the like, according to claim 1, wherein said readily inflatable body has a plurality of independent sections which, when associated with one another, define the predetermined shape of said printing device.

5. An inflatable full scale model of a printing device, or the like, according to claim 4, wherein said plurality of sections of said readily inflatable body are maintained in association with one another by suitable fastener mechanisms.

6. A method for assessing suitability of a site for a selected printing device, or the like, said method comprising the steps of:
providing an inflatable full scale model of a printing device, or the like, having a predetermined shape, when inflated, corresponding to a selected printing device with features representing utility hook-up locations for the selected printing device;
inflating said full scale printing device model at a site, such as a desired customer site; and
assessing the site location, with the full scale printing device model inflated, to determine whether the site can properly accommodate the selected printing device, and from the utility hook-up features of the full scale printing device model, whether the site has access to necessary utility connections at proper locations.

7. A method for assessing suitability of a site for a selected printing device, or the like, according to claim 6, wherein said step of assessing utility connections includes evaluating the status of at least one of the following utilities: electric power connections, compressed air connections, water connections, drain connections, network connections, modem connections, or environmental control system connections.

8. A method for assessing suitability of a site for a selected printing device, or the like, according to claim 6, further including providing a readily inflatable body having a predetermined shape, when inflated, corresponding to a full scale model of an accessory for said selected printing device, and associating said full scale model of said accessory with said full scale model of said printing device.

9. A method for assessing suitability of a site for a selected printing device, or the like, according to claim 6, wherein said provided readily inflatable body has a plurality of sections, and associating said plurality of sections with one another to define the predetermined shape of said printing device.

10. A method for assessing suitability of a site for a selected printing device, or the like, according to claim 6, wherein in the step of assessing the site location, fastening together said plurality of sections of said readily inflatable body to establish the predetermined shape corresponding to said selected printing device.
